(19) United States
(12) Patent Application Publication
(10) Pub. No.: US 2008/0027155 A1
(43) Pub. Date: Jan. 31, 2008

(54) Thermally Conductive Material for Electronic and/or Electrical Components, and Use Thereof

(75) Inventors: Heiner Bayer, Olching (DE); Michael Decker, Regensburg (DE); Dieter Heinl, Weisendorf (DE)

Correspondence Address: YOUNG & THOMPSON, 745 SOUTH 23RD STREET, 2ND FLOOR, ARLINGTON, VA, 22202, US

(73) Assignee: SIEMENS AKTIENGESELLSCHAFT SIEMENS AG, 80506 MUNICH (DE)

(21) Appl. No.: 10/592,784

(22) PCT Filed: Mar. 9, 2005
(86) PCT No.: PCT/EP05/51056

§ 371 Date: Oct. 13, 2006

(30) Foreign Application Priority Data
Mar. 15, 2004 (DE) 10 2004 012 546.5

(51) Int. Cl. C08F 2/46; C08F 10/08; C08F 4/609

(52) U.S. Cl. 522/31; 522/109; 522/110

(57) ABSTRACT

A thermally conductive and electrically insulating material, especially a paste, for mounting electrical and/or electronic components in housings and/or on cooling elements. The material is free of silicons and has a high filling ratio with moderate viscosity.

The invention relates to a material, in particular a paste, for mounting electrical and/or electronic assemblies in housings and/or on cooling elements, which is thermally-conductive and electrically-insulating.

Printed circuit boards with electronic assemblies are mounted on cooling elements or in housings, whereby they are connected in a thermally-conductive manner and/or are mechanically supported. In this way, many electrical devices or electronic devices are also electrically insulated to a great extent, for instance those used in the motor vehicle industry to levels of up 1000 volts and above. The materials preferably used at present for this are filled gels or pastes based on silicon.

The silicon-based materials essentially have two disadvantages here: firstly volatile elements, which are released over time, and secondly migrable components, which inhibit or adversely effect, even in the smallest quantities, further surface treatments such as coating, bonding and/or painting. In addition, the materials must be applied in a very precise manner, as contaminations can only be completely removed again with difficulty.

Furthermore, many materials exhibit a high adhesion factor, in other words they adhere easily, so that once the circuit boards are equipped with components and connected in a thermally-conductive and electrically insulating manner, they cannot simply be released or dismantled again, for repair purposes for instance. With known materials of this type, in the event of repairs, the entire assembly must always be replaced, because repairs are uneconomical or impossible.

Furthermore, a number of materials are mostly needed to meet all the requirements such as chemical and thermal stability and mechanical shock resistance etc. In addition, the silicon-based materials generally lack ease of application, gas emission freedom and/or migration freedom.

The object of the present invention is thus to make available a material which is thermally-conductive and electrically insulating, which is suitable for processing in large-scale productions, thus has a moderate initial viscosity, and does not adhere in a cured state and does not exhibit the disadvantages of silicons.

The subject of the invention is a thermally-conductive and electrically-insulating material, free of silicons, comprising at least the following components:
a) a trifunctional or higher functional polyol,
b) an epoxy component
c) a photoinitiator system and
d) 65 to 80 percent by weight of a thermally-conductive, UV-permeable filler material.

In the case of silica dust, the material is advantageously displaced with 70 to 80 percent by weight of filler material. It preferably has a filling degree of 72 to 78 percent by weight and particularly preferably a filling degree of 73.5 to 77 percent by weight. These specifications in percent by weight apply to the filler material with the density of silica dust. It is known to a person skilled in the art that the volume filling ratio, that is the preferred weight ratio, differs decisively for filler materials with different densities.

The epoxy component is advantageously bifunctional so that in combination with the high proportion of polyol functionality in the copolymer mixture, molecules with a high molecular weight but with a low cross-linking degree result.

The polyol component advantageously comprises a polyvinyl butyral and/or a trifunctional polyester polyol.

The degree of acetalization of the polyvinyl butyral is preferably selected to be 75% or higher, which is favorable for a low cross-linking density. The trifunctional polyester polyol component is likewise preferably also selected with a high molecular weight, preferably with a molar weight exceeding 800 g/mol. At the same time, the molar masses are chosen still sufficiently small so that it is still possible to dose and apply the material accordingly.

The further molar mass structure is then carried out with the curing, after the radiation.

This enables the risk of migrable components and volatile elements in the material to be kept as small as possible, at least with a cured material. In the mixtures according to the invention, the polyols used are basically stable against demixing due to incompatibility and/or insolubility.

The material is selected according to one embodiment, such that in the prepolymer initial components, in other words the as yet unpolymerized and/or cured organic (“organic” here in the sense of “carbonaceous”) substances, in respect of functional groups, more hydroxy groups are contained than epoxy groups.

The polymer matrix along with the additives and the filler material is a storage-stable 1-K system which lasts several months at room temperature with a moderate initial viscosity of 50-250 Pas, and thus a good processability (working life of 1 hour and more after initiation) with a good curing behavior (radiation times sometimes less than 1 minute).

In accordance with the invention, a low, but noticeable cross-linking and adhesion is aimed at, in order to produce the combination of reliable thermal conductivity and reparability of the entire device, i.e. the ability of the components to be released from the thermally-conductive paste.

Natural rubber or rubber-like final characteristics of the finished paste are thus aimed for. Harder rubber or glass-like compositions are also conceivable here.

The photoinitiator is preferably an acid-releasing UV photoinitiator, a type of triaryl sulfonium salt for instance, also in combination with a sensitizer, in other words a starter system, for instance an isopropyl thioxanthon. The photoinitiator can also be improved for instance by combination with a thermal initiator system.

The chemical base for the binder forms a cationic copolymerization of epoxydized resins with polyols, with it being preferable for more polyol than epoxy resin to be present in the reaction mixture.

The filler materials are preferably mineral filler materials, which combine thermal conductivity with UV transparency.

A person skilled in the art knows how to achieve high filling degrees with a moderate viscosity, e.g. by combining filler material with a different grain size distribution.

Filler materials which do not have an alkali character but instead a neutral or even acid character are particularly advantageous, in particular those which are short of basic byproducts. By way of example, aluminum oxide, silica dust and/or further crystalline silicon dioxide components are mentioned as filler materials. It is decisive here for the filler material to be selected such that a UV-initiated curing takes place despite the high filling degree, with a specific thermal post-curing, for instance 1-30 minutes at a temperature between 50° C. and 100° C, which completes the curing, not being excluded.

The system can also still contain typical additives, such as colorings (provided they do not inhibit the UV curing), defoamers and/or cross-linking additives.

When the material for thermally-conductive contacting is used, the finished uncured mixture made from epoxy and polyol components with filler material, photoinitiator and additives is applied to the cooling element, the electronic or electrical component (the integrated circuit) the wiring board and/or the printed circuit board. The curing is initiated by means of UV radiation, then the components, printed circuit board, assembly and housing or cooling facilities are mounted, in other words screwed together for example, connected by a spring or the like. After hardening is completed, a rubber-like material is produced, which establishes the contact between the printed circuit boards equipped with components, the cooling element and/or the housing. Sometimes, an additional temper step is carried out to complete the hardening process.

The finished material is a polymer, which comprises the poly-β-hydroxy ether structures, which are the result of the conversion of the epoxy component with the hydroxyl component. The initial components produce the polyester units (polycaprolacton triol) and the longer C—C chains (of polybutyral). Once all epoxy functions have calmed down, the material is sufficiently stable to withstand the demands and test scenarios within the motor vehicle industry for instance.

The material was developed in respect of its use in electronics and electrical engineering, in particular for heat dissipation, for thermally-conductive contacting and/or for mechanical stabilization, e.g. against vibrations, of electronic devices on printed circuit boards and/or in housings.

The invention is described in more detail below with reference to an example:

The substances listed in the table below are combined, mixed in a corresponding apparatus and degassed in the vacuum:

| Quantity | Composition |
|---|---|
| 32.0 g | Cycloaliphatic epoxy resin |
| 14.4 g | Epoxydized soya bean oil |
| 3.20 g | Polyvinyl butyral |
| 97.4 g | Trifunctional polyester polyol |
| 2.35 g | Triaryl sulfonium hexafluoroantimonate |
| | (photoinitiator) |
| 0.095 g | Isopropyl thioxanthone |
| 0.30 g | Defoamer |
| 340.97 | Quartz |
| 85.24 | Quartz |
| 1.5 | Soda lime glass |

The polyvinyl butyral products can vary both in respect of the molar mass as well as in respect of their acetalization degree and finally in respect of their proportion of hydroxy groups.

The initial viscosity of the heat-conductive material should be as small as possible, between 50 and 250 Pas for instance (measured with a plate or cone viscosimeter).

After a few seconds of radiation, the viscosity of 80 increases to more than 500 Pas, so that the mounting can be carried out during the next hour or somewhat longer, without a complete curing process taking place.

The thermal conductivity of the material is significantly dependent on the filling degree and on the filler material, for instance a thermal conductivity of at least 0.7 W/mK can be reached with a filling degree of 75 percent by weight (silica dust). Higher filling degrees and more powerful thermally-conductive filler material produce a higher thermal conductivity of the material.

The following advantages are achieved for the first time by the inventive material:
the material can be easily applied, because it has a moderate initial viscosity suitable for this purpose,
surplus material can be easily removed again
mechanical unevenesses are balanced and holes filled
no silicon content, therefore no unwanted byproducts
a simple disassembly for repair purposes, because the material only exhibits low adhesion
low thermal contact resistance, because the thermally-conductive material can be applied over a large area over the entire device and thus ensures optimum heat dissipation
only one material is necessary, which covers both the conductor board or printed circuit board as well as the assembly parts located thereupon
less cost-intensive curing conditions (radiation with UV light)
material is cross-linked when in a completely cured state, therefore enabling components and printed circuit boards embedded in the material to withstand high vibration loads.
possibility of double-sided SMD equipping without additional housing

The present invention relates to a material, in particular a paste, for mounting electrical and/or electronic components in housings and/on cooling elements, which is thermally conductive and electrically insulating. This material which is being presented for the first time is free of silicons, exhibits a high thermal conductivity with a high filling degree and moderate viscosity. The end state is achieved after UV activation during thermal post curing if required.

1. A thermally-conductive and electrically insulating material, comprising at least the following components:
a) a trifunctional or higher functional polyol
b) an epoxy component
c) a photoinitiator system and
d) 65 to 80% percent by weight of a thermally-conductive filler material

2. The material as claimed in claim 1, with the epoxy component being bifunctional.

3. The material as claimed in claim 1, with more hydroxy groups being contained in the prepolymer initial components, in respect of functional groups, than epoxy groups.

4. The material as claimed in claim 1, with the polyol being a polyvinyl butyral and/or a trifunctional polyester polyol.

5. The material as claimed in claim 1, with the polyol being a polyvinyl butyral and the acetalization degree of the polyvinyl butyral being more than 75% and/or the molar mass of the trifunctional polyester polyol component being more than 800 g/mol.

6. The material as claimed in claim 1, with the photoinitiator being a type of triaryl sufonium salt.

7. The material as claimed in claim 1, with the filler material not exhibiting any alkali character, but instead a neutral or even an acid character.

8. (canceled)

9. The material as claimed in claim 2, with more hydroxy groups being contained in the prepolymer initial components, in respect of functional groups, than epoxy groups.
